(19) United States
(12) Patent Application Publication
(10) Pub. No.: US 2007/0125810 A1
(43) Pub. Date: Jun. 7, 2007

(54) Container with a device to discharge product

(76) Inventors: Thorsten Blum, Darmstadt (DE); Johannes Burghaus, Gross-Umstadt (DE); Stefan Hopp, Ingelheim (DE); Ronald Wienziers, Heusenstamm (DE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/418,637

(22) Filed: May 5, 2006

(30) Foreign Application Priority Data
May 6, 2005 (DE) 102005020956.4

(51) Int. Cl. B67D 3/00; F16K 7/04

(52) U.S. Cl. 222/511; 251/7

(57) ABSTRACT

In order to enable removal of any quantity of product with a container (1) with a device (2) to discharge product, particularly trickling or free-flowing product, with a reservoir (3) to hold the product, a product discharge opening (4), and a connection (5) between the reservoir (3) and the device (2), it is suggested that the container (1) have a channel (6), made of flexible material, which is provided for routing the product from the reservoir (3) up to the product discharge opening (4), that the device (2) have a clamping element (7) for optional clamping and releasing of the channel (6), that the clamping element (7) be spring-loaded in the direction of the channel (6) using a spring (8), and that an actuator device (9) be connected to the clamping element (7) via actuation mechanics (10), to enable optional clamping of the channel (6) via manual actuation of the actuator device (9).

The object of the invention relates to a container to discharge product, particularly to provide granulate in the hair salon industry.

Granulate-type hair treatment agent is used in hair salons. Said treatment agent should be manually removable from a container in a simple manner in that the use of one of the user's hands should be sufficient to remove the product so that the user has the other hand available for a different function.

A container according to the preamble of Claim 1 is known from DE 34 38 677 A1. This container has a device to discharge product, which is a reservoir to hold the product. A product discharge opening is used for product exiting, and a connection between the reservoir and the device serves as a one-piece design of the container.

The known container has the disadvantage that only one predetermined volumed quantity of product can be discharged from the releasing device. The removal quantity cannot be varied.

The object was to further develop the object according to the preamble of Claim 1, which would overcome this disadvantage.

The object is achieved according to the distinguishing component of Claim 1. Accordingly, the container has a channel made of flexible material, which is provided for routing the product from the reservoir up to the product discharge opening. The device has a clamping element for optional clamping and release of the channel. The clamping element is spring-loaded using a spring in the direction of the channel, and an actuator device is connected to the clamping element via actuation mechanics to provide the option of clamping the channel via manual actuation of the actuator device.

The suggested container has the advantage that any desired product quantity can be removed. A user can allow a product stream to flow out of the product discharge opening by actuating, from time to time, the actuator device, which is provided for product outlet. In this process, the user is the one that determines the duration of the product output stream for any desired product quantity. The container can be used with one hand in a simple manner.

Advantageous embodiments of the container according to the invention are described in Claims 2 through 6.

With the container arranged upside down, the product contained in the reservoir is only dispensed while the actuator device is being actuated if, according to Claim 2, the actuator device is connected to actuation mechanics designed as a surrounding structure, wherein the channel extends through the structure and is positioned at one side of the structure, and wherein the clamping element is positioned on the side of the channel opposite the side, and the spring is provided between the clamping element and the structure. An actuator knob or a button is suitable for the actuator device. When the actuator device is pressed, a container that is positioned upside down is opened in that the channel that was previously clamped closed by the clamping element as well as the actuation mechanics is released. Once the actuator device is released, the spring moves the actuation mechanics back into a position that is once again compressive for the channel and thereby seals it back up. Alternatively, an actuation could be used to clamp the channel. An elastically deformable tube (Claim 3), particularly one made of plastic, is suitable for the channel.

A funnel on the connection (Claim 4) routes the product flowing out of the reservoir into the channel.

If the container has a longitudinally extended shape according to Claim 5, on one end of which the product discharge opening is provided, said container can be grasped like a pen and held. For easier holding, even with wet hands, particularly in the hair salon industry, it is advantageous if a container expansion is provided on the end of the container that is opposite the product discharge opening (Claim 6).

The invention is described in detail below with reference to Figures that show an exemplary embodiment. The following is shown:

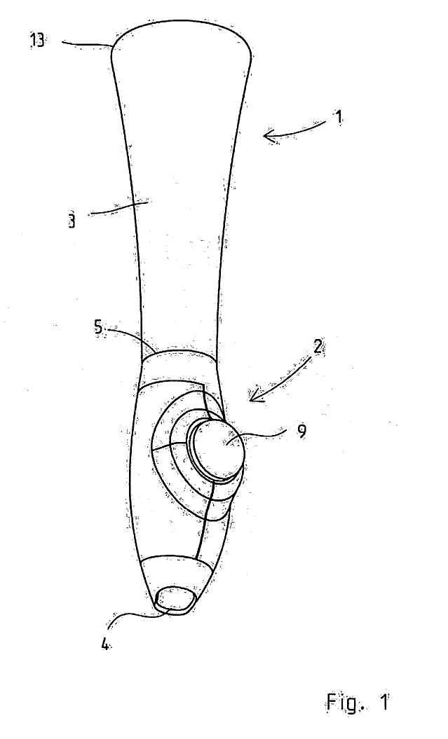

FIG. 1 shows a perspective view of a container with an actuator device designed as an actuator knob to discharge free-flowing product;

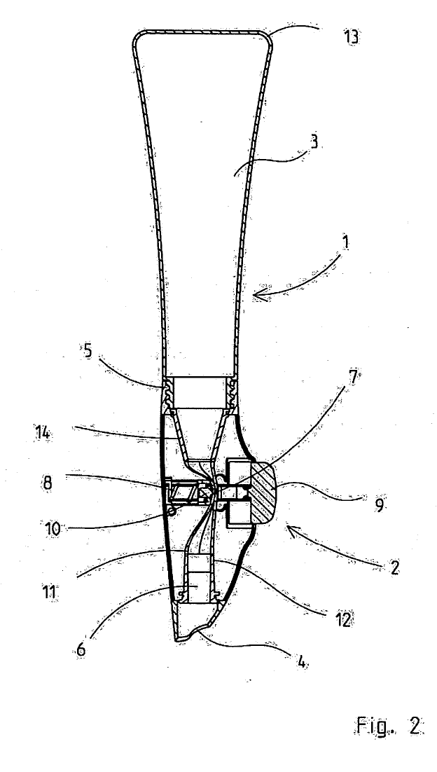

FIG. 2 shows a side view with a partial cut-out of the container of FIG. 1 without the actuator device being pressed and the resulting clamped channel;

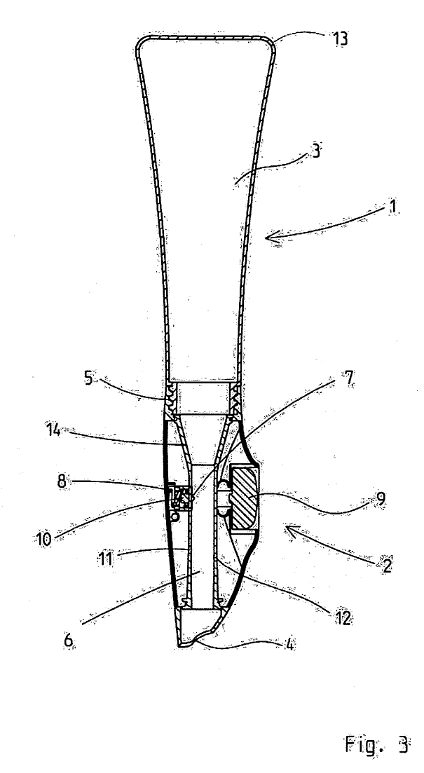

FIG. 3 shows a side view with a partial cut-out of the object of FIG. 2, but with the actuator device being pressed thus releasing the channel for product discharge;

FIG. 4 shows a sectional representation of the actuation mechanics of the container with the condition according to FIG. 2; and

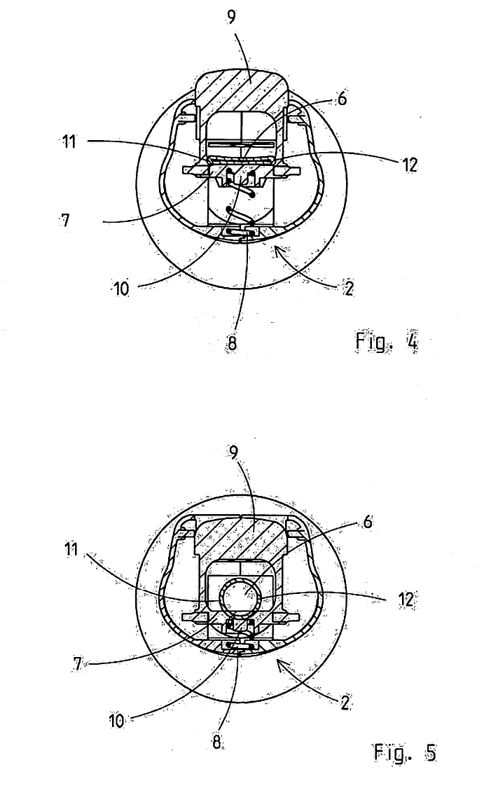

FIG. 5 shows a sectional representation of the actuation mechanics of the container according to FIG. 3.

A container 1 (FIG. 1) has a device 2 to discharge product, particularly trickling or free-flowing product, with a reservoir 3 to hold the product, and a product discharge opening 4 has a connection 5 between the reservoir 3 and the device 2, which is executed as a screw connection. The container 1 has a tube-shaped, deformable channel 6, made of a flexible material, which is provided for routing the product from the reservoir 3 up to the product discharge opening 4. The device 2 has a clamping element 7 for optional clamping and release of the channel 6. The clamping element 7 is spring-loaded using a spring 8 in the direction of the channel 6. An actuator device 9 is connected to the clamping element 7 via actuation mechanics 10 to provide the option of clamping the channel 6 via manual actuation of the actuator device 9 (FIG. 2) or to make the product permeable (FIG. 3).

The actuator device 9, which is an actuator knob, is rigidly connected to the actuation mechanics 10, which are designed as a surrounding structure (FIG. 4, FIG. 5). The channel 6 extends through the structure. On one side 11, it is positioned at the structure. The clamping element 7 is positioned at the side 12 of the channel 6 opposite this side 11. The spring 8 is provided between the clamping element 7 and the structure in order to apply the force necessary for clamping when the actuator device is released.

The container 1 is held downwards in order to dispense the product with the product discharge opening 4, wherein product flows from the reservoir 3 through a funnel 14 into the channel 6. A container expansion 13 is provided, on the end of the longitudinally extended container 1 that is opposite the product discharge opening 4, for improving manually holding the container 1, which can be used with one hand.

### REFERENCE LIST

1 Container

2 Device for discharging

3 Reservoir

4 Product discharge opening

5 Connection

6 Channel

7 Clamping element

8 Spring

9 Actuator device

10 Actuator device

11, 12 Side

13 Container expansion

14 Funnel

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A container (1) comprising a device (2) to discharge product, particularly trickling or free-flowing product, comprising a reservoir (3), a product discharge opening (4), and a connection (5) between the reservoir (3) and the device (2), wherein the container (1) comprises a channel (6), which comprises a flexible material, which is provided for routing the product from the reservoir (3) up to the product discharge opening (4), the device (2) comprises a clamping element (7) for optional clamping and releasing of the channel (6), the clamping element (7) is spring-loaded in the direction of the channel (6) using a spring (8), and wherein an actuator device (9) is connected to the clamping element (7) via actuation mechanics (10), to enable optional clamping of the channel (6) via manual actuation of the actuator device (9).

2. A container according to claim 1, wherein the actuator device (9), which is preferably an actuator knob, is connected to actuation mechanics (10) designed as a surrounding structure, the channel (6) extends through the structure and is positioned on one side (11) of the structure, the clamping element (7) is positioned on the side (12) of the channel (6) opposite the first side (11), and the spring (8) is provided between the clamping element (7) and the structure.

3. A container according to claim 1, wherein the channel (6) is an elastically deformable tube.

4. A container according to claim 1, wherein the channel (6) comprises a funnel (14), expanded towards the connection (5), at the connection (5).

5. A container according to claim 1, wherein the container (1) comprises a longitudinally extended shape, on one end of which the product discharge opening (4) is provided.

6. A container according to claim 5, wherein a container expansion (13) is provided on the opposite end.
